(19) United States
(12) Patent Application Publication
(10) Pub. No.: US 2008/0137343 A1
(43) Pub. Date: Jun. 12, 2008

(54) Method and apparatus for improving light quality emitted from an HMD lightsource

(75) Inventors: Attila Saghy, Mosonmagyarovar (HU); Andras Molnar, Budapest (HU); Laszlo Domjan, Budapest (HU); Gabor Szarvas, Budapest (HU)

Correspondence Address: FULBRIGHT & JAWORSKI L.L.P, 2200 ROSS AVENUE, SUITE 2800, DALLAS, TX, 75201-2784, US

(73) Assignee: Headplay, Inc., Calgary (CA)

(21) Appl. No.: 11/635,891

(22) Filed: Dec. 8, 2006

(51) Int. Cl. F21V 7/00; G02B 6/34

(52) U.S. Cl. 362/297; 385/36

(57) ABSTRACT

A method and apparatus for improving the quality of light emitted from an HMD lightsource. A backlight-type lightsource is disclosed that utilizes a reflective end-wall 17 to reflect light within the lightguide. Light emitted from an illumination source and reflected from the end-wall 17 combine within the lightguide to produce light with high contrast and homogeneity. A microprism array, consisting of microprisms of uniform height and equidistant spacing, is positioned along the bottom surface of the lightguide. A portion of the combined light incident upon the microprism array is reflected in a direction substantially perpendicular to the lightguide top surface, which comprises an aperture. Light having increased brightness and homogeneity passes through the aperture. Light incident upon the top surface outside of the aperture is reflected within the lightguide so that it may subsequently be transmitted through the aperture.

### TECHNICAL FIELD

The invention generally relates to visual displays and more specifically to a lightsource for a head mounted display that uses a large aperture, small size lightsource.

### BACKGROUND OF THE INVENTION

Head-Mounted Displays (HMD) are a class of image display devices that can be used to display images such as those from television, digital versatile discs, computer applications, game consoles, and other similar applications. An HMD can be monocular (a single image viewed by one eye), biocular (a single image viewed by both eyes), or binocular (a different image viewed by each eye). Further, the image projected to the eye(s) may be viewed by the user as complete or as superimposed on the user's view of the outside world. Effective HMD designs typically account for providing a lightsource that will adequately illuminate the image seen by the HMD user.

To be effective as a lightsource in an HMD, a proposed design should be sufficiently small in size, should produce relatively bright and homogenous light, and should provide tri-color (red, green, blue, also know as “RGB”) illumination with minimal coloration effects. (In most HMD applications, tri-color illumination refers to red, green, and blue lightsources being at different positions. As such, the angle and position of the resulting light distribution may vary according to color.) However, the smaller a lightsource design becomes, the more difficult it is for that lightsource to produce quality light.

Typical backlight designs are geared to large scale applications. Lightsources are used to illuminate relatively large surfaces, such as LCD-monitors and microdisplays. For example, these displays are illuminated by emitting light from a large area of the lightguide so that light is diffused over its entire surface. As a result, light is homogenous, but has low brightness. This is generally acceptable for applications that do not require intense light. However, HMD applications typically require intense light dispersed over a much smaller surface area of the lightsource. Accordingly, there is a need for a lightsource that is small enough to be used in an HMD that produces bright, homogeneous light with minimal coloration effects.

Some arrangements attempt to improve light brightness and homogeneity in small scale backlight applications by manipulating microprisms within the lightguide (a process generally referred to as “depth modulation”). These arrangements typically vary the height of individual microprisms and the spacing between microprisms, to specifically direct light within the guide and improve brightness and homogeneity. Unfortunately, this requires complex microprism structures, which increases complexity in both the design and assembly of the lightsource.

Another problem relating to backlight-type lightsources relates to loss of light during transmission, as light may be lost when the microprisms direct light outside of a desired range. In some cases, efficiency is lost as light reflected from the microprism structure is reflected outside of an aperture relied upon to facilitate transmission of the light from the lightguide to an illuminated body.

### BRIEF SUMMARY OF THE INVENTION

The present invention combines light reflected within a lightguide with direct light emitted from a lightsource and directs the combined light for use, thereby improving the overall quality of light emitted from the lightsource. Embodiments of the invention may accomplish this by providing a reflective backwall within the lightguide. This reflective backwall allows direct light, emitted from an illumination source, and the reflected light to combine within the lightguide, thereby increasing homogeneity and brightness. Also, reflective materials are strategically placed within the lightguide to improve efficiency of the transmission of light. As a result, the lightsource improves the quality of emitted light and provides homogenous light, both in position and angle-space, having high brightness. Moreover, the lightsource is of a dimension suitable to be employed in an HMD.

In an exemplary embodiment, an illumination unit and a lightguide are positioned with respect to one another where light propagates in a lightguide at a cone angle determined by the angle of Total Internal Reflection (TIR). The lightguide is of substantially rectilinear form, having side walls, a back wall, a bottom wall, and a top wall. The top wall has an aperture therein. On the bottom wall there is a microprism array. As light propagates through the lightguide, a portion is reflected within the lightguide by the side walls. The portion of light incident upon the rear wall, which comprises reflective material, is reflected within the lightguide. As a result, direct light from the illumination unit is combined with reflected light from the back wall by the microprism array on the bottom surface, thereby providing increased light brightness and homogeneity within the lightguide.

The microprism array that is symmetrical about a central portion of the lightguide. The prism angle is chosen so that light propagating at, or approximately equal to, one half of the angle of TIR is directed substantially perpendicular to the lightguide top surface aperture. Light incident upon the microprism array, which comprises both direct and reflected light, is reflected in a direction substantially perpendicular to the lightguide top surface aperture. As such, the combined light is effectively transmitted through the aperture. That portion of light reflected by the microprism array outside of the aperture is reflected by material surrounding the aperture. Thereby, the reflected light is given subsequent opportunity to later be transmitted through the aperture, which increases the overall efficiency of light transmission from the lightsource.

### BRIEF DESCRIPTION OF THE DRAWINGS

FIG. 1 illustrates a top view of lightsource 10 arranged according to an embodiment of the present invention.

FIG. 2 illustrates a side view of lightsource 10 arranged according to an embodiment of the present invention.

FIG. 3 illustrates a top view of lightsource 10 arranged according to another embodiment of the present invention.

FIG. 4 illustrates a top view of lightsource 10 arranged according to yet another embodiment of the present invention.

FIG. 5 illustrates a perspective view of lightsource 10 arranged in an exemplary system according to the present invention.

### DETAILED DESCRIPTION OF THE INVENTION

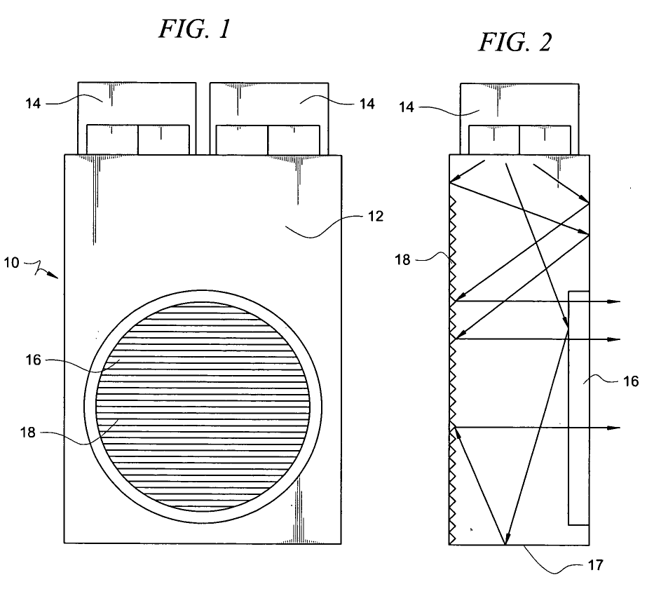

FIGS. 1 and 2 illustrate an example lightsource 10 arranged according to one embodiment of the present invention. In FIG. 1, lightsource 10 utilizes lightguide 12, which may be comprised of an optical-quality plastic block. Other embodiments are envisioned where lightguide 12 comprises other materials, such as silica-based composites. During operation, illumination unit 14 emits light toward lightguide 12. Light propagates within lightguide 12 in a particular cone angle, which is defined by the material of the lightguide 12. This angle is the angle of TIR. As discussed, embodiments of lightsource 10 are anticipated for primary use in HMD applications; therefore, lightguide 12 is of a suitable size to be used in conjunction with an HMD. Accordingly, in the embodiment of FIG. 1, lightguide 12 is approximately 7 mm×10 mm×3 mm in dimension and is of rectilinear form. Of course, one of ordinary skill in the art will recognize that other dimensions are suitable as well.

Referring to FIGS. 1 and 2, the surface of the end-wall 17 of lightguide 12 comprises a reflective material so that light incident upon its surface is reflected within lightguide 12. As seen in FIGS. 1 and 2, the top surface of lightguide 12 has aperture 16, which in a preferred embodiment is approximately 6 mm in diameter. Aperture 16 does not comprise reflective material; however, as mentioned, light propagates through lightguide 12 at the angle of TIR. Therefore, light emitted from illumination unit 14 and incident upon aperture 16 is reflected within lightguide 12. As best seen in FIG. 2, as a result, light is not able to pass through aperture 16 until after it has been reflected by microprism array 18, in a direction substantially perpendicular to aperture 16. Generally, microprism array 18 is larger than aperture 16 and therefore reflects light outside of aperture 16. However, an area of reflective coating surrounding aperture 16 reflects such light back within lightguide 12. As a result, light that does not initially pass through aperture 16 is given subsequent opportunities to eventually pass through.

As light propagates within lightguide 12 at the angle of TIR, it is reflected by the sidewalls towards end-wall 17. When the light reaches the end-wall, it is reflected within lightguide 12. The overall effect is an increase in brightness and homogeneity of light within lightguide 12. That is, brightness and homogeneity are increased as direct light, emitted from illumination unit 14, is combined with light reflected from end-wall 17. Increasing homogeneity within the lightguide 12 by virtue of reflective end-wall 17 allows microprism array 18 to be relatively simple in design. This is in contrast with typical backlight-type sources, which require depth modulation, or manipulation of height and spacing of individual microprisms, to improve the light brightness.

In the embodiment of FIGS. 1 and 2, microprism array 18 comprises individual microprisms placed along the bottom surface of lightguide 12. By virtue of the increased brightness and homogeneity, the microprisms are uniformly spaced from one another and are of a uniform height. Further, microprism array 18 is symmetrical about a central axis of lightguide 12. Preferably, each microprism is an elongate cone that substantially spans the length of lightguide 12. Other useful embodiments are envisioned where each microprism in array 18 is of a tetrahedral shape, so that light incident upon each microprism could reflected in multiple directions. Also, in a preferred embodiment, each microprism encloses a 34.5 degree angle with the bottom surface of lightguide 12. This prism angle is chosen so that light propagating at half of the angle of TIR is reflected in a direction substantially perpendicular to aperture 16. As best seen in FIG. 2, this angle is preferred as it establishes that light incident upon microprism array 18 is reflected in a direction substantially perpendicular to aperture 16. Specific angles of microprisms depend on, among other things, the dimension of lightguide 12 itself and may vary according to particular embodiments. Specific dimensions have been discussed for illustrative purposes, those skilled in the art will recognize useful variations.

As discussed above, embodiments of lightsource 10 are further characterized by illumination unit 14. In the illustrated embodiment, illumination unit 14 comprises one or more Light Emitting Diodes (LED). LEDs are desirable in that they provide sufficient RGB illumination while being of a suitably small size. Those skilled in the art will recognize that illumination unit 14 may comprise other components. For example, incandescent emitters are thought to also be useful in some embodiments.

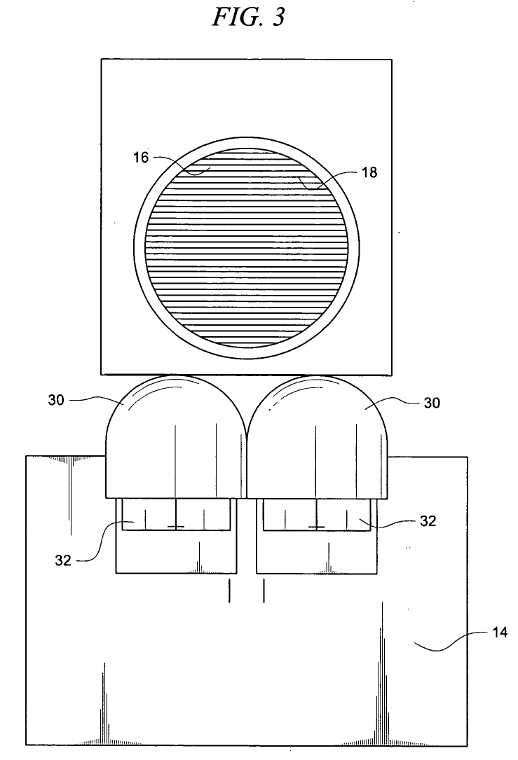

Referring now to FIG. 3, an alternative embodiment is shown where illumination unit 14 comprises cylindrical lenses 30 and LEDs 32. Components of illumination unit 14 may be joined by an adhesive means as known in the art. According to FIG. 3, illumination unit 14 comprises 2 LEDs 32 and 2 cylindrical lenses 30; however, useful embodiments are envisioned having one or more LEDs and one or more cylindrical lenses. In this embodiment, cylindrical lenses 30 serve to collimate light emitted from LEDs 32 in one dimension. As a result, light brightness increases and angle space and light distribution can be easily controlled with a diffuser (not shown). Such diffusers are commonly used in (HMD) applications.

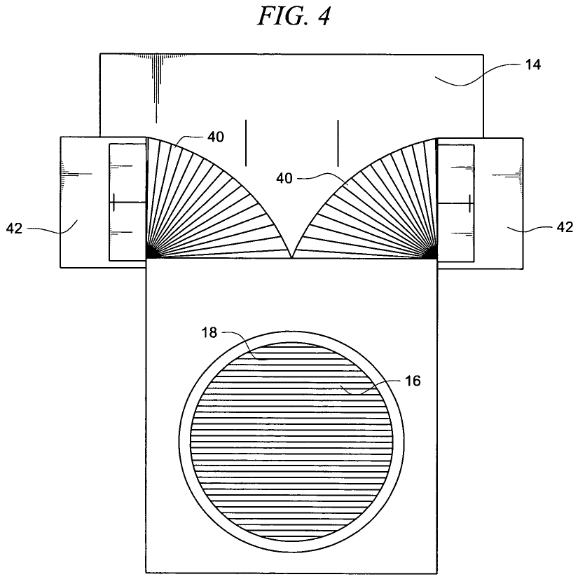

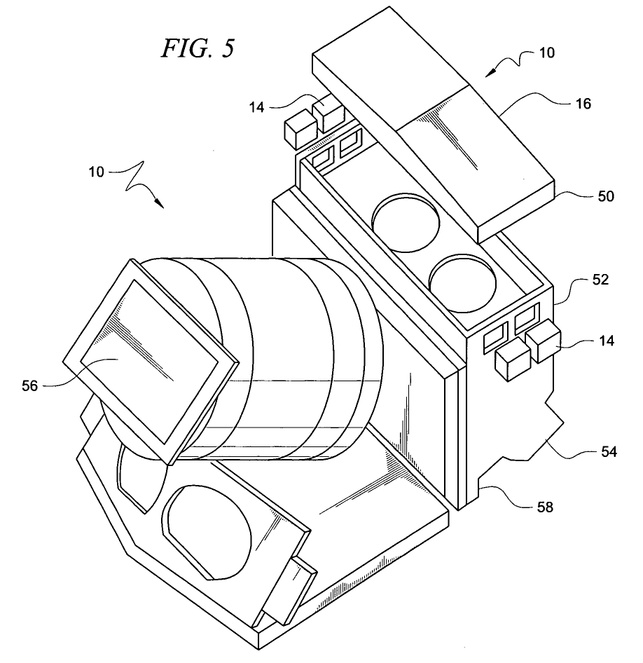

Referring now to FIG. 4, another embodiment is shown where illumination unit 14 comprises parabolic reflectors 40 and LEDs 42. Components of illumination unit 14 may be joined by an appropriate method as known in the art. According to FIG. 4, illumination unit 14 comprises 2 LEDs 42 and 2 parabolic reflectors 40; however, useful embodiments are envisioned having one or more LEDs 42 and one or more parabolic reflectors 40. In this embodiment, parabolic reflectors 40 serve to collimate light emitted from the LEDs in one dimension. As a result, light brightness increases and angle space and light distribution can be easily controlled with a diffuser (not shown). Such diffusers are commonly used in HMD applications.

As seen in FIG. 5, an embodiment of lightsource 10 is depicted in combination with an exemplary HMD. In this embodiment, lightsource 10 is secured within a housing 50. Aperture 16 aligns with housing aperture 52 to facilitate the transmission of light therethrough. In some embodiments, housing aperture 52 may contain, or be in combination with, a diffuser(not shown) or brightness enhancement film. In most embodiments, a diffuser may be placed in housing aperture 52 to improve homogeneous angular distribution. As light passes through housing aperture 52, that light is reflected towards microdisplay 56 by prism 54. Also, in this embodiment polarizer 58 is positioned between prism 54 and microdisplay 56. Polarizer 58 is used to improve the contrast of light received at microdisplay 56.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for improving the quality of light emitted from an HMD lightsource, said method comprising:
propagating light through a lightguide;
reflecting a first portion of said propagated light from a wall of said lightguide, said first portion being substantially reflected within the lightguide;
combining at least some of said first portion with a portion of light directly emitted from a lightsource; and
directing at least some of said combined light through an aperture within said lightguide.

2. The method of claim 1 wherein said directing is accomplished, at least in part, by a plurality of microprisms.

3. The method of claim 2 wherein said microprsims are arranged in array fashion.

4. The method of claim 2 wherein said microprisms are of substantially uniform dimension and are substantially uniformly spaced from one another.

5. The method of claim 3 wherein said microprism array is symmetrical about a central portion of said lightguide.

6. The method of claim 2 wherein said microprisms are substantially tetrahedral in shape.

7. The method of claim 1 wherein said directing comprises reflecting a portion of said combined light in a plane substantially orthogonal to said aperture.

8. The method of claim 1 wherein said propagating light at substantially the angle of TIR within said lightguide.

9. The method of claim 1 further comprising the step of:
reflecting a portion of said directed light from reflective material surrounding said aperture within said lightguide.

10. The method of claim 1 wherein said propagating is accomplished using one or more LEDs.

11. A Head Mounted Display lightsource comprising:
an illumination unit for emitting light;
a lightguide adjacently positioned along said illumination unit, said lightguide having a reflective end-wall 17 for reflecting a portion of said emitted light so that a portion of said reflected light is combined with a portion of said emitted light within said lightguide; and
a reflective mechanism positioned within said lightguide and configured to direct a portion of said combined light in through an aperture of said lightguide.

12. The lightsource of claim 11 wherein said reflective mechanism is a plurality of microprisms.

13. The lightsource of claim 12 wherein said microprisms are arranged in array fashion.

14. The lightsource of claim 12 wherein said microprisms are of substantially uniform dimension and are substantially uniformly spaced from one another.

15. The lightsource of claim 13 wherein said microprism array is symmetrical about a central portion of said lightguide.

16. The lightsource of claim 12 wherein said microprisms are substantially tetrahedral in shape.

17. The lightsource of claim 11 wherein light is reflected from said reflective mechanism in a plane substantially orthogonal to said aperture.

18. The lightsource of claim 11 wherein said light emitted from said illumination unit propagates at substantially the angle of TIR within said lightguide.

19. The lightsource of claim 11 wherein said lightguide aperture is substantially surrounded with reflective material.

20. The lightsource of claim 11 wherein said illumination unit comprises one or more RGB LEDs.

21. A method for illuminating a display screen of an HMD comprising:
combining light emitted from an illumination unit and light reflected within a lightguide in said lightguide;
reflecting a portion of said combined light incident upon a microprism array in a plane substantially orthogonal to an aperture of said lightguide;
transmitting said portion of said combined light through said aperture of said lightguide;
reflecting said portion of said combined light from a prism toward said display screen; and
transmitting said portion of said combined light through a polarizer to said display screen.

22. The method of 2 wherein each microprism of said plurality of microprisms is an elongate cone.

23. The lightsource of claim 12 wherein said microprisms are an elongate cone.
